(19) United States
(12) Patent Application Publication
(10) Pub. No.: US 2007/0155272 A1
(43) Pub. Date: Jul. 5, 2007

(54) Felt for forming fiber cement articles having stretch-resistant yarns

(76) Inventors: Thomas Baumgartner, Warth (AT); Hippolit Gstrein, Gloggnitz (AT)

Correspondence Address: MYERS BIGEL SIBLEY & SAJOVEC, PO BOX 37428, RALEIGH, NC, 27627, US

(21) Appl. No.: 11/322,513

(22) Filed: Dec. 30, 2005

(51) Int. Cl. D04H 1/08; B32B 13/02; B32B 5/16; B32B 5/26; B32B 13/10; B32B 5/02; B32B 9/02

(52) U.S. Cl. 442/320; 442/324; 442/325; 442/326; 428/294.7

(57) ABSTRACT

A fiber cement felt includes: a base fabric including a set of machine direction (MD) yarns and a set of cross machine direction (CMD) yarns interwoven with the MD yarns in a plurality of repeat units, wherein between about 5 and 95 percent of the MD yarns are stretch-resistant yarns; and a batt layer overlying and attached to the fabric. A fiber cement felt of this configuration can exhibit improved stretch-resistance and tenacity.

### FIELD OF THE INVENTION

The present invention relates generally to fabrics, and more particularly to fabrics employed to form articles of fiber cement.

### BACKGROUND OF THE INVENTION

Fiber cement is a well-known material employed in many building components, such as siding, roofing and interior structures, and pipes, particularly for waste water transport. Fiber cement typically comprises a mixture of cement (i.e., lime, silica and alumina), clay, a thickener, inorganic fillers such as calcium carbonate, and one or more fibrous materials. In the past, asbestos was commonly included as the fibrous material (see U.S. Pat. No. 4,216,043 to Gazzard et al.); because of the well-documented problems asbestos presents, now fiber cement typically includes a natural or synthetic fiber, such as acrylic, aramid, polyvinyl alcohol, polypropylene, cellulose or cotton. Fiber cement is popular for the aforementioned applications because of its combination of strength, rigidity, impact resistance, hydrolytic stability, and low thermal expansion/contraction coefficient.

To be used in siding or roofing components, fiber cement is often formed in sheets or tubes that can be used “as is” or later cut or otherwise fashioned into a desired shape. One technique of forming fiber cement articles is known as the Hatschek process. A fiber cement forming apparatus using the Hatschek process typically includes a porous fabric belt positioned on a series of support rolls. An aqueous fiber cement slurry of the components described above is created and deposited as a thin sheet or web on the porous fabric belt. The slurry is conveyed by the fabric belt over and through a series of rollers to flatten and shape the slurry. As the slurry is conveyed, moisture contained therein drains through openings in the fabric. Moisture removal is typically augmented by the application of vacuum to the slurry through the fabric (usually via a suction box located beneath the porous fabric). After passing through a set of press rolls, the fiber cement web can be dried and cut into individual sheets, collected on a collection cylinder for subsequent unrolling and cutting into individual sheets or slates, or collected as a series of overlying layers on a collecting cylinder that ultimately forms a fiber cement tube.

The porous fabric used to support the slurry as moisture is removed is typically woven from very coarse (between about 1000 and 4000 dtex) polyamide yarns. Most commonly, the yarns are woven in a “plain weave” pattern, although other patterns, such as twills and satins, have also been used. Once they are woven, the yarns are covered on the “sheet side” of the fabric (i.e., the side of the fabric that contacts the fiber cement slurry) with a batt layer; on some occasions, the “machine side” of the fabric (i.e., the side of the fabric that does not contact the slurry directly) is also covered with a batt layer. The batt layer assists in the pick-up and dewatering of the slurry from a vat or other container for processing. Because of the presence of the batt layer(s), the fabric is typically referred to as a fiber cement “felt.”

Coarse yarns have typically been employed in fiber cement felts because of the severe conditions the felt experiences during processing. For example, fiber cement felts are typically exposed to high load conditions by the forming machine. Also, there can be significant variations in tension over the felt length on the fiber cement machine, as tension may vary from as low as 2 kilopounds/cm after the forming roll to as high as 15 kilopounds/cm over suction boxes. As a result, coarse yarns having high “tenacity” and resilience have been employed. However, because the yarns are coarse, such felts have a tendency to mark the surface of the fiber cement product formed thereon, sometimes to a sufficient degree that smoothing of the surface in a subsequent operation may be required. Further, fiber cement felts are typically prone to “blinding” (the filling of the openings in the fabric mesh with fiber cement slurry) and typically must be cleaned frequently and may be removed (depending on machine conditions such as speed and load) after as little as one week. Also, such felts tend to suffer significant “compaction” (the tendency of the felt to decrease in thickness) with use. Compaction is detrimental to operation in that, as the felt decreases in thickness, the pressure exerted on the fiber cement by the pressing rolls can change, thereby altering the surface characteristics as well as overall physical properties of the sheet. Also, some compaction may be localized, with the result that the fiber cement can have areas of different thickness. Accordingly, once felts have become compacted, they are typically replaced.

Fiber cement felts typically include one or more base fabric layers that are formed into endless belts. An exemplary multi-fabric, or “laminated,” felt is described in U.S. Pat. No. 5,891,516 to Gstrein et al., and an exemplary multi-layer base fabric is described in U.S. Patent Publication No. US-2005-0085148-A1; the disclosures of each of these applications are hereby incorporated herein in their entireties. The base fabric layers can be “flat-woven” and permanently joined after weaving into an endless belt, or the fabric layers can be woven in endless form. The longitudinal ends of flat-woven fabrics are generally joined in order to form an endless belt. Some seamed felts are also known (see, e.g., U.S. patent application Ser. No. 10/953,165, filed Sep. 29, 2004, the disclosure of which is hereby incorporated herein in its entirety).

Currently, it is common to weave the base fabrics of fiber cement felts from polyamide (i.e. nylon), either as spun yarns or as twisted yarns formed of multifilament and spun yarns. However, it has been noted that fiber cement felts tend to be susceptible to stretching, particularly in the machine direction, during operation. Such stretching can cause the fabric to increase in length up to 8 percent or greater. The stretching of fabric can, in some instances require removal of the felt from the machine, as it may exceed the maximum spindle length of the machine.

### SUMMARY OF THE INVENTION

As a first aspect, embodiments of the present invention are directed to a felt for making fiber cement slates or tubes. The fiber cement felt comprises: a base fabric including a set of machine direction (MD) yarns and a set of cross machine direction (CMD) yarns interwoven with the MD yarns in a plurality of repeat units, wherein between about 5 and 95 percent of the MD yarns are stretch-resistant yarns; and a batt layer overlying and attached to the fabric. A fiber cement felt of this configuration can exhibit improved stretch-resistance and tenacity.

As a second aspect, embodiments of the present invention are directed to a fiber cement felt comprising a base fabric and a batt layer overlying and attached to the felt. The base fabric includes a set of machine direction (MD) yarns and a set of cross machine direction (CMD) yarns interwoven with the MD yarns in a plurality of repeat units. At least some of the MD yarns comprise stretch-resistant material and non-stretch-resistant material.

As a third aspect, embodiments of the present invention are directed to a method of forming fiber cement comprising the steps of: (a) providing a fiber cement felt; (b) depositing a fiber cement slurry on the fiber cement felt; and (c) removing moisture from the slurry. The fiber cement felt comprises a fabric including a set of MD yarns and a set of CMD yarns interwoven with the MD yarns in a plurality of repeat units, wherein between about 5 and 95 percent of the MD yarns are stretch-resistant yarns, and a batt layer overlying and attached to the set of top machine direction yarns of the fabric.

As a fourth aspect, embodiments of the present invention are directed to a method of forming fiber cement comprising the steps of: (a) providing a fiber cement felt; (b) depositing a fiber cement slurry on the fiber cement felt; and (c) removing moisture from the slurry. The fiber cement felt comprises: a fabric including a set of machine direction (MD) yarns and a set of cross machine direction (CMD) yarns interwoven with the MD yarns in a plurality of repeat units, wherein at least some of the MD yarns comprise stretch-resistant material and non-stretch-resistant material; and a batt layer overlying and attached to the set of top machine direction yarns of the fabric.

### BRIEF DESCRIPTION OF THE FIGURES

FIG. 1 is a schematic illustration of a fiber cement forming apparatus according to embodiments of the present invention.

FIG. 2 is a greatly enlarged top perspective view of the felt of the fiber cement apparatus of FIG. 1.

FIG. 3 is a section view of the felt of FIG. 2.

### DETAILED DESCRIPTION OF EMBODIMENTS OF THE INVENTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

As used herein, the terms “machine direction” (MD) and “cross machine direction” (CMD) refer, respectively, to a direction aligned with the direction of travel of the fiber cement felt on a fiber cement forming machine, and a direction parallel to the fabric surface and transverse to the direction of travel. Also, both the flat weaving and endless weaving methods described hereinabove are well known in this art, and the term “endless belt” as used herein refers to belts made by either method.

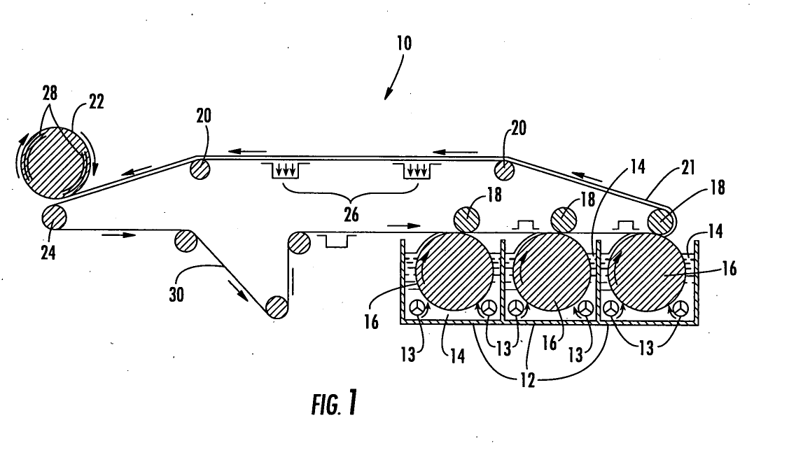

Referring now to FIG. 1, a fiber cement forming apparatus, designated broadly at 10, is illustrated therein. The forming apparatus 10, which performs a typical Hatschek process, generally includes an endless fiber cement felt 30 positioned in rolling contact with and driven by a number of guide rolls 20. Beginning in the lower right corner of FIG. 1, the felt 30 passes above three vats 12, each of which contains a batch of fiber cement slurry 14. As used herein, “fiber cement” means any cementitious composition including cement, silica, and fiber for reinforcement, including asbestos, polyvinyl alcohol, polypropylene, cotton, wood or other cellulosic material, acrylic, and aramid. It is contemplated that other materials such as thickeners, clays, pigments, and the like, that impart desirable processing or performance characteristics to the fiber cement slurry 14 or an article formed therefrom may also be included. Each vat 12 is positioned below a deposition cylinder 16 mated with a couch roll 18. Each vat 12 also includes agitators 13, which prevent the fiber cement slurry 14 from solidifying therein.

Rotation of each deposition cylinder 16 collects fiber cement slurry 14 on the cylinder's surface; as the felt 30 travels over and contacts the cylinder 16, the slurry 14 is transferred from the cylinder 16 to the felt 30. The amount of slurry 14 deposited on the fabric 30 by each cylinder 16 is controlled by the corresponding couch roll 18. Typically, the fiber cement slurry 14 is deposited as a web 21 at a thickness of between about 0.3 mm and 3 mm.

Still referring to FIG. 1, once the fiber cement slurry web 21 has been collected on the felt 30 from each of the vats 12, the felt 30 conveys the slurry web 21 over one guide roll 20, then over one or more suction boxes 26 (two are shown in FIG. 1), each of which applies negative pressure to the felt 30, thereby encouraging the removal of moisture from the slurry web 21. Finally, the felt 30 and the slurry web 21 pass over a second guide roll 20, then between the nip formed by a breast roll 24 and a forming roll 22. After passing through the nip, the slurry web 21 has formed into a semi-solid fiber cement sheet 28 that is collected on the surface of the forming roll 22.

Those skilled in this art will recognize that other forming apparatus are also suitable for use with the fiber cement felts of the present invention. For example, felts of the present invention can also be used to form fiber cement pipes. In such an operation, the fiber cement sheet 28 can be collected in contacting layers on a forming roll; as they dry, the overlying layers form a unitary laminated tube. Often, a pipe forming apparatus will include small couch rolls that act in concert with the forming roll to improve interlaminar strength. Also, a second felt may travel over the additional couch rolls to assist in water absorption and finishing.

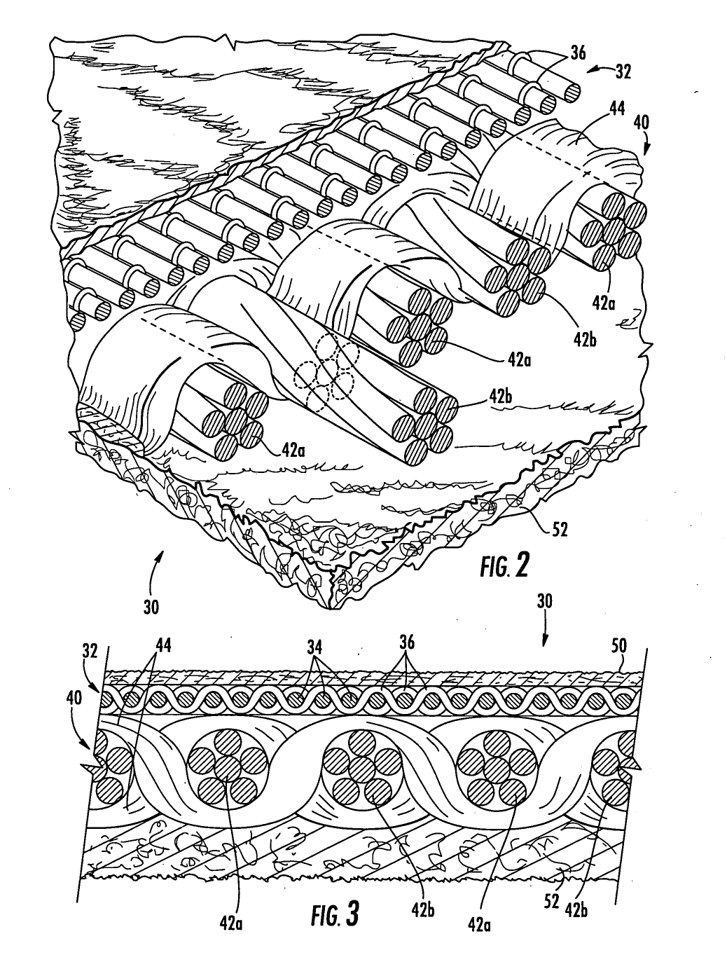

Referring now to FIGS. 2 and 3, the felt 30 includes two distinct fabric layers: a top fabric layer 32 and a bottom fabric layer 40. The felt 30 also includes a batt layer 50 that overlies the top fabric layer 32 and a bottom batt layer 52 that underlies the bottom fabric layer 40. These layers are described in greater detail below.

Referring again to FIGS. 2 and 3, the top fabric layer 32 is illustratively a plain weave fabric comprising interlaced MD yarns 34 and CMD yarns 36. The yarns comprising the top layer 32 are fine yarns that can reduce the tendency of the felt 30 to cause marking on the fiber cement sheet 28 formed thereon. Reduced sheet marking can result from processing with a finely woven mesh because the close proximity of the fine yarns to one another can support both ends of fibers within the fiber cement rather than allowing one end of a fiber to reside with the gap between yarns, as can happen with a coarser mesh.

In some embodiments, the MD yarns 34 are somewhat coarser than the CMD yarns 36; the machine direction yarns 34 can range in fineness from 500 to 4,000 tex, and the CMD yarns 36 can range in fineness from 30 to 3,000 tex. As used herein, “tex” refers to the well-known unit of fineness used to describe textile yarns, in which the number of “tex” is equal to the mass in grams of a 1000 meter length of yarn. An exemplary top fabric layer 32 comprises 140 tex MD yarns and 140 tex CMD yarns. Those skilled in this art will recognize that fabric patterns other than a plain weave, such as a 1×2, 1×3, or 1×4 twill, a satin, or other weave pattern known to those skilled in this art, can also be used in the top layer 32 of the present invention.

The form of the yarns utilized in the top fabric layer 32 can vary, depending upon the desired properties of the felt 30. For example, the yarns may be multifilament yarns, monofilament yarns, twisted multifilament or monofilament yarns, spun yarns, core-wrapped yarns, or any twists or other combination thereof. In some embodiments, the MD yarns 34 and the CMD yarns 36 can be twists of multifilaments and spun yarns. Also, the materials comprising yarns employed in the fabric of the present invention may be those commonly used in fiber cement felts. For example, the yarns 34, 36 may be formed of cotton, wool, polypropylene, polyester, polyamide, or the like, with polyamide yarns being most common for both the MD yarns 34 and the CMD yarns 36. Of course, the skilled artisan should select yarn materials according to the parameters of the fiber cement forming process.

Still referring to FIGS. 2 and 3, the illustrated bottom fabric layer 40 also comprises a plain weave fabric, although other weave patterns, such as twills and satins as mentioned above, may also be employed. The bottom fabric layer 40 includes interwoven MD yarns 42a, 42b and CMD yarns 44, which are described below.

The MD yarns 42a include stretch-resistant material. As used herein, the term “stretch-resistant” means that the material comprising the yarn has a low elongation, e.g., a breaking elongation of 1 to 4% at a specific tenacity of about 150 cN/tex of the yarn or of 5 to 7% at a specific tenacity of about 80 cN/tex of the twisted material. Exemplary stretch-resistant materials include aromatic polyamide (i.e., aramid), polyphenylene sulfide (PPS), poly-paraphenylene terephthalamide (sold under the trade name Kevlar®), and the like. The stretch-resistant MD yarns 42a may be multifilament yarns, monofilament yarns, twisted multifilament or monofilament yarns, spun yarns, core-wrapped yarns, or any twists or other combination thereof. In some embodiments, the stretch-resistant MD yarns 42a may be formed as spun yarns, twisted yarns, or bundled yarns.

The MD yarns 42b are of conventional construction. They may be multifilament yarns, monofilament yarns, twisted multifilament or monofilament yarns, spun yarns, core-wrapped yarns, or any twists or other combination thereof. Typically, the MD yarns 42b will be formed of polyamide.

In the bottom fabric layer 40, the stretch-resistant MD yarns 42a may comprise between 5 and 95 percent of the total number of MD yarns 42a, 42b. In some embodiments, the stretch-resistant MD yarns 42a may comprise between about 35 and 65 percent of the total number of MD yarns in the bottom fabric layer 40. In certain embodiments, the stretch-resistant MD yarns 42a may comprise between about 45 and 55 percent of the total number of MD yarns in the bottom fabric layer 40.

In other embodiments, some or all of the MD yarns 42a, 42b of the bottom fabric layer 40 may comprise a combination of stretch-resistant material (such as aramid, PPS, Kevlar® and the like) and non-stretch-resistant material (such as polyamide). Typically an MD yarn that includes both stretch-resistant material and non-stretch-resistant material will include between 5 and 95 percent stretch-resistant material, more typically between about 35 and 65 percent stretch-resistant material, and in some embodiments between about 45 and 55 percent stretch-resistant material, with the remainder of the yarn comprising non-stretch-resistant material. In certain embodiments all of the MD yarns 42a, 42b are formed of a combination of stretch-resistant material and non-stretch resistant material.

The CMD yarns 44 may be any form, depending upon the desired properties of the felt 30. For example, the CMD yarns 44 may be multifilament yarns, monofilament yarns, twisted multifilament or monofilament yarns, spun yarns, core-wrapped yarns, or any twists or other combination thereof. The materials comprising yarns employed in the fabric of the present invention may be those commonly used in fiber cement felts. For example, the CMD yarns may be formed of cotton, wool, polypropylene, polyester, polyamide, or the like, with polyamide yarns being most common. In some embodiments, some of the CMD yarns may also include stretch-resistant yarns or combination yarns of the types discussed above.

Both the top and bottom fabric layers 32, 40 are illustrated as “single layer” fabrics, i.e., they include single sets of machine direction yarns and cross machine direction yarns. However, it is contemplated for the present invention that either or both of the top and bottom fabric layers 32, 40 may be “double layer” fabrics (i.e., they may include top and bottom sets of machine direction yarns interwoven and bound with a set of cross machine direction yarns) or “triple layer” fabrics (i.e., they have top and bottom sets of interwoven machine direction yarns and cross machine direction yarns). Also, for certain applications, the top and bottom fabric layers 32, 40 may exchange positions. In addition, the felt 20 may be formed of only a single fabric, i.e., the top fabric layer 32 may be omitted. Further, the felt 20 may be woven endless or flat, and may be seamed or otherwise joined if flat-woven.

As indicated in FIG. 3, the top fabric layer 32 and bottom fabric layer 40 are attached to one another to prevent relative lateral movement therebetween. In some embodiments, the top fabric layer 32 may be heat bonded to the bottom fabric layer 40, although they can also be attached through needling or other known fastening methods.

Referring still to FIGS. 2 and 3, the top batt layer 50 overlies the top fabric layer 32, and the bottom batt layer 52 underlies the bottom fabric layer 40. The batt layers 50, 52 are included to assist in the take-up of fiber cement slurry 14 from the vats 12. The batt layers 50, 52 are typically attached by needling, but can be attached to the top and bottom fabric layers 32, 40 by other methods known to those skilled in this art.

The batt layers 50, 52 may be formed of material, such as a synthetic fiber like acrylic aramid, polyester, or polyamide, or a natural fiber such as wool, that assists in taking up fiber cement slurry 14 from the vats 12 to form the fiber cement web 21. The materials for certain embodiments include polyamide, polyester and blends thereof. The weight of the batt layers 50, 52 can vary, although it is preferably that the ratio of batt weight to fabric weight is about between about 1.0 and 2.0 with 1.5 being more preferred. Also, in some embodiments, it may be desirable to omit the bottom batt layer 52.

The presence of the stretch-resistant MD yarns 42a in the felt 30 can provide significant stretch resistance to the felt 30. For example, in a felt having a single layer base fabric of the construction set forth in Table 1, the felt exhibited an elongation of less than 5 percent and demonstrated excellent tenacity.

TABLE 1

| | Material | Fineness (tex) | Yarn Type |
|---|---|---|---|
| MD Yarns | Combination Yarn of | 3,000 | Spun |
| | 50% Kevlar ® and | | |
| | 50% Polyamide | | |
| CMD Yarns | Polyamide | 1000 | Spun |

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A felt for making fiber cement slates and tubes, comprising:
a base fabric including:
a set of machine direction (MD) yarns; and
a set of cross machine direction (CMD) yarns interwoven with the MD yarns in a plurality of repeat units;
wherein between about 5 and 95 percent of the MD yarns are stretch-resistant yarns; and
a batt layer overlying and attached to the fabric.

2. The fiber cement felt defined in claim 1, wherein between about 35 and 65 percent of the MD yarns are stretch-resistant yarns.

3. The fiber cement felt defined in claim 1, wherein between about 45 and 55 percent of the MD yarns are stretch-resistant yarns.

4. The fiber cement felt defined in claim 1, wherein the stretch-resistant yarns are formed of a material selected from the group consisting of: aramid, PPS and poly-paraphenylene terephthalamide.

5. The fiber cement felt defined in claim 1, wherein the stretch-resistant yarns are formed of aramid.

6. The fiber cement felt defined in claim 1, wherein the stretch-resistant yarns are formed of a material having a breaking elongation of between about 1 and 4 percent at 150 cN/tex for the yarn.

7. The fiber cement felt defined in claim 1, further comprising an upper fabric layer that overlies the base fabric.

8. The fiber cement felt defined in claim 7, wherein the upper fabric layer is woven from fine yarns.

9. The fiber cement felt defined in claim 1, wherein the MD yarns that are not stretch-resistant yarns are formed of polyamide.

10. The fiber cement felt defined in claim 1, wherein the MD yarns have a fineness between about 500 and 4,000 tex.

11. The fiber cement felt defined in claim 10, wherein the CMD yarns have a fineness between about 30 and 3,000 tex.

12. A felt for making fiber cement slates and tubes, comprising:
a base fabric including:
a set of machine direction (MD) yarns; and
a set of cross machine direction (CMD) yarns interwoven with the MD yarns in a plurality of repeat units;
wherein at least some of the MD yarns comprise stretch-resistant material and non-stretch-resistant material; and
a batt layer overlying and attached to the fabric.

13. The fiber cement felt defined in claim 12, wherein each of the MD yarns of the base fabric comprises stretch-resistant material and non-stretch-resistant material.

14. The fiber cement felt defined in claim 12, wherein the MD yarns comprise between about 35 and 65 percent stretch-resistant material.

15. The fiber cement felt defined in claim 12, wherein the MD yarns comprise between about 45 and 55 percent stretch-resistant material.

16. The fiber cement felt defined in claim 12, wherein the stretch-resistant material is selected from the group consisting of: aramid, PPS and poly-paraphenylene terephthalamide.

17. The fiber cement felt defined in claim 12, wherein the stretch-resistant material is aramid.

18. The fiber cement felt defined in claim 12, wherein the stretch-resistant material has a breaking elongation of between about 1 and 4 percent at 150 cN/tex for the yarn.

19. The fiber cement felt defined in claim 12, further comprising an upper fabric layer that overlies the base fabric.

20. The fiber cement felt defined in claim 19, wherein the upper fabric layer is woven from fine yarns.

21. The fiber cement felt defined in claim 12, wherein the non-stretch-resistant material comprises polyamide.

22. The fiber cement felt defined in claim 12, wherein the MD yarns have a fineness between about 500 and 4,000 tex.

23. The fiber cement felt defined in claim 22, wherein the CMD yarns have a fineness between about 30 and 3,000 tex.

24. A method of forming a fiber cement article, comprising the steps of:
(a) providing a fiber cement felt, the fiber cement felt comprising:
a fabric including:
a set of machine direction (MD) yarns; and
a set of cross machine direction (CMD) yarns interwoven with the MD yarns in a plurality of repeat units;
wherein between about 5 and 95 percent of the MD yarns are stretch-resistant yarns; and
a batt layer overlying and attached to the set of top machine direction yarns of the fabric;
(b) depositing a fiber cement slurry on the fiber cement felt; and
(c) removing moisture from the slurry.

25. A method of forming a fiber cement article, comprising the steps of:
(a) providing a fiber cement felt, the fiber cement felt comprising:
a fabric including:
a set of machine direction (MD) yarns; and
a set of cross machine direction (CMD) yarns interwoven with the MD yarns in a plurality of repeat units;
wherein at least some of the MD yarns comprise stretch-resistant material and non-stretch-resistant material; and
a batt layer overlying and attached to the set of top machine direction yarns of the fabric;
(b) depositing a fiber cement slurry on the fiber cement felt; and
(c) removing moisture from the slurry.
